(19) United States
(12) Patent Application Publication
(10) Pub. No.: US 2020/0191570 A1
(43) Pub. Date: Jun. 18, 2020

(54) CAPSULE FOR A COMPASS AND USE THEREOF

(71) Applicant: STEINER-OPTIK GMBH, Bayreuth, OT (DE)

(72) Inventors: Matthias RUCKDESCHEL, Bayreuth (DE); Werner MAYR-WENT, Emtmannsberg, OT (DE)

(73) Assignee: STEINER-OPTIK GMBH, Bayreuth, OT (DE)

(21) Appl. No.: 16/616,635

(22) PCT Filed: May 11, 2018
(86) PCT No.: PCT/EP2018/062248

§ 371 Date: Nov. 25, 2019

(30) Foreign Application Priority Data
Jun. 9, 2017 (DE) 10 2017 112 745.3

(51) Int. Cl. G01C 17/08

(52) U.S. Cl. CPC G01C 17/08

(57) ABSTRACT

The invention relates to a capsule for a compass and use thereof. The capsule has a housing designed in multiple parts for receiving at least one scale device (10) for reading at least one geographical indication, wherein the scale device (10) is arranged mounted on a mounting device (8), and the housing has a cover part (2) for upper closure of the housing and a base part (4) for lower closure of the housing, wherein the cover part (2) and base part (4) are permanently connected to each other via a perforated shell surface (6). Furthermore, the capsule has a pressure equalization element (18) arranged around the housing and spanning the shell surface (6) at least in part for equalizing pressure fluctuations of a liquid medium arranged in the compass capsule (1), wherein the pressure equalization element (18) is designed in an elastic manner.

The invention relates to a capsule for a compass, comprising at least one housing that is formed in multiple parts, and use thereof. At least one scale device for reading off at least one geographical specification is arranged in the fluid medium itself, in a manner mounted on a bearing device.

Conventional compass capsules are known from the prior art, which capsules are formed of a housing comprising fluid medium arranged therein. In turn, a scale is provided in the housing itself, which scale is often designed as a rose. Said scale is rotatably mounted on a corresponding pin. Petroleum or paraffin oil is often used as the fluid medium, because these long-chain hydrocarbons have a sufficiently high viscosity to damp the rose correspondingly, in the alignment thereof, and to allow for good legibility of the at least one geographical specification.

However, it has been found in practice to be disadvantageous to provide long-chain hydrocarbons as a fluid medium in the compass capsule.

If large temperature fluctuations occur between the surroundings, in particular the compass capsule housing and the medium arranged therein, the medium and housing generally react with different coefficients of thermal expansion. This leads to undesired air bubble formation in the fluid medium. This degassing is generally irreversible and results in the formed air bubble attaching to the upper face of the compass capsule. An air bubble of this kind is disadvantageous in particular if the compass capsule is provided in binoculars, in such a manner that while looking through the binoculars the scale device of the compass, i.e. the at least one geographical specification should correspondingly be read at the same time. Even very small air bubbles have been found to be disadvantageous in this case, because as a result, the movement of the scale device, i.e. of the rose, is incorrectly or too greatly damped, and misreadings thus occur. Furthermore, the air bubbles under the transparent cover glass also impair the legibility of the scale device. Thus, overall, the readout result is significantly impaired and falsified.

For this reason, the object of the present invention is that of providing a compass capsule which is designed so as to be permanently bubble-free and/or in which air bubbles that form can be easily removed from the scale device.

This object is achieved according to the features of claim 1.

For this purpose, the capsule according to the invention for a compass, i.e. a compass capsule, comprises a housing that is formed in multiple parts and is intended for receiving at least one scale device. The scale device is used for reading off at least one geographical specification. In this case, a geographical specification is intended to mean in particular at least one geographical position determination and/or at least one cardinal direction and/or at least one time measurement and/or at least one speed measurement and/or degree specification and/or line specification.

The scale device is arranged so as to be mounted on a bearing apparatus, for example a pin. If the compass capsule according to the invention is used for insertion in a magnetic compass, the scale device further comprises at least one magnetic element. As a result, the function of said compass type is ensured.

A further, essential point of the invention consists in the housing being formed in multiple parts, and comprising a cover part for closing the housing at the top, and a base part for closing the housing at the bottom. The cover part and base part are rigidly interconnected around the periphery by means of a perforated lateral surface. In the simplest case, the compass capsule is thus cylindrical.

The lateral surface is therefore designed as a connecting piece connecting the cover part and base part. The lateral surface rigidly interconnects the cover part and the base part. This rigid connection can be achieved for example by means of adhesion or welding. Additional sealing can of course also be provided by means of sealing rings that are arranged accordingly.

In the simplest case, the lateral surface is made of low-cost plastics material and/or metal.

Of course, the cylindrical shape of the compass capsule is not to be understood as limiting, but rather it is also conceivable for the housing to be spherical. In this case, the cover part and the base part would accordingly be formed so as to be hemispherical. Here, too, both parts would be rigidly interconnected by a lateral surface. In the case of the spherical design of the compass capsule, the lateral surface is arranged above the equator plane of the spherical compass capsule.

Furthermore, the compass capsule according to the invention comprises a pressure compensation element that is arranged peripherally around the housing and spans the lateral surface at least in part. Said pressure compensation element is advantageously designed for compensating pressure fluctuations of the fluid medium arranged in the compass capsule.

For this purpose, according to the invention the pressure compensation element is resilient. The combination, provided for the first time, of the perforated lateral surface, which is advantageously completely spanned by the pressure compensation element, and the resilient pressure compensation element, makes it possible, for the first time, for pressure fluctuations of the fluid medium to be balanced and compensated in a simple manner. Disadvantageous degassing processes of the fluid medium, and air bubble formation, are thus significantly reduced or, at best, prevented.

For this purpose, according to the invention the pressure compensation element is resilient. As a result of this, said element can compensate the compressive and/or tensile force application, induced by the fluid medium, inside the compass capsule. When an increased pressure builds up as a result of the fluid medium, the resulting compressive force is applied to the pressure compensation element that is arranged on the outside, around the housing. Owing to the resilient, flexible nature thereof, the pressure compensation element undergoes elastic deformation. In this case, a convex outward deformation of the pressure compensation element takes place.

The fluid medium can expand sufficiently, as a result of which the degassing of the fluid medium is reduced or even prevented. In the present case, resilient is advantageously intended to mean that the original state, not subjected to force application, is assumed again once the application of force has ended. If the pressure in the compass capsule reduces again, the deformation of the pressure compensation element thus also reduces, for example until said element returns to the original position and/or original shape not subjected to force application.

If the pressure compensation element were to be formed so as to be rigid and inflexible, the compressive force acting thereon would remain in the housing or in the compass capsule, and the degassing of the fluid medium, and the associated air bubble formation, would be promoted.

In the case of reduced pressure of the fluid medium, the pressure compensation element is subjected to a tensile force, concavely towards the inside. In the case of this movement direction, too, owing to the resilient design thereof the pressure compensation element brings about pressure compensation in the entire compass capsule and/or in the housing. This, too, reduces degassing of the fluid medium.

Therefore, a compass capsule is provided in a particularly simple and cost-effective manner, in which capsule the air bubble formation is reduced.

If an air bubble should nonetheless be formed in the housing, for example owing to extreme temperature fluctuations, said bubble can be transferred, via the perforations of the lateral surface, out of the housing and into the volume spanned by the pressure compensation element, and retained there. This, to, makes it possible for the housing itself to remain free of air bubbles.

The compass capsule described herein can advantageously be designed having a transparent cover part made of glass or plastics materials. This is advantageous since a transparent cover part means that the scale device can accordingly also be read without problem. Of course, this is not to be understood as limiting, and therefore it is also conceivable to make the cover part and/or base part of plastics materials or metal and to merely arrange a transparent observation window. Depending on the design of the compass capsule as a cylinder or sphere, the observation window can be arranged in a variable manner, wherein it is always ensured that the scale device can be read through the observation window.

Advantageously at least one long-chain alkane, for example paraffin oil or petroleum, is used as the fluid medium. The fluid medium has a high viscosity in the range of from 0.6 to 1,000,000 mPas. More advantageously, the fluid medium has a viscosity in the region of from 130,000 to 230,000 mPas or from 150,000 to 200,000 mPas or from 180,000 to 190,000 mPas. Particularly advantageously, the fluid medium has a viscosity in the region of from 186,000 to 188,000 mPas.

Furthermore, the fluid medium can have a density in the range of from 0.65 g/cm³-1.07 g/cm³. Particularly advantageously, the fluid medium has a density in the range of from 0.73 to 0.85 g/cm³. In this density range, the functionality of the compass capsule is particularly good.

It is furthermore also conceivable for the fluid medium to comprise a plurality of different alkanes, such as paraffin oil and petroleum, and to be formed as a mixture of substances.

Further advantageous embodiments can be found in the dependent claims.

In a further advantageous embodiment, the resilient pressure compensation element is formed of at least one plastics material, at least one metal foil, or at least one composite material, or a combination thereof. Forming the pressure compensation element of at least one plastics material has been found to be advantageous because plastics material itself is cost-effective to manufacture.

Depending on the raw polymer, the degree of polymerization thereof and the isomerization thereof, the resilient behavior of the pressure compensation element can be set in a purposeful manner.

In the simplest case, the pressure compensation element comprises at least for example polyimide and/or polymethylmethacrylate and/or polyvinylchloride and/or acrylonitrile as the plastics component. These components can be present individually and/or in combination with one another, for example as a cross-linked polymer matrix, individual polymer chains, monomer units, block copolymer units, or as polymer blends.

Depending on the design, it is also conceivable to form the pressure compensation element from a plurality of plastics components, for example as a statistical copolymer and/or block copolymer and/or polymer blend.

In an advantageous embodiment, in order to form permanent resiliency the pressure compensation element further comprises at least one plasticizer. This is particularly advantageously an integrated plasticizer. Said plasticizer is directly polymerized into the polymer matrix, i.e. into the plastics material, during the material manufacture and/or when manufacturing the pressure compensation element.

Particularly advantageously, the pressure compensation element comprises at least 1 to 35 wt. % polymerizable plasticizer, based on the total mass of the plastics material. This is in particular selected from the group of the polybutadienes, various acrylates such as polymethyl acrylate, polymethylmethacrylate, vinyl acetate, alkenes such as ethene, methyl acrylate or a combination thereof, contained as a copolymer and/or polymer blend. Furthermore, plasticizers based on ester and/or ether are also conceivable, for example polyglycol ether, or resins.

In addition to being formed of plastics material, it is also conceivable to form the pressure compensation element as a resilient metal film. This is possible for example as a result of an enlarged surface of the metal film. In the simplest case, the surface is designed so as to be corrugated or jagged.

This is of course not intended to be understood as limiting, and therefore it is also conceivable to form the pressure compensation element from a composite material. A composite material of this kind can consist for example of fiber-reinforced plastics material which maintains a specifiable resiliency as a result of the selection and arrangement of the fibers within the plastics matrix. Conceivable fibers are inorganic fibers such as SiO₂ fibers, or carbon fibers, or the fiber bundles thereof, which are embedded in an elastomer matrix, for example silicone rubber.

It has been found to be particularly advantageous for the pressure compensation element to comprise, in a further embodiment, at least one elastomer as a component. An elastomer is understood to be all elastically deformable plastics materials, the glass transition temperature of which is below the use temperature. The elastic deformation is designed so as to be reversible at a corresponding compressive or tensile load.

In this case, this may be at least one natural and/or a synthetic elastomer. An example for a natural elastomer is for example vulcanized natural rubber. An example for a synthetic elastomer is for example vulcanized synthetic rubber. This can be selected, depending on the requirements, from the following group of rubbers: Rubbers having a saturated carbon backbone chain (M-rubber), for example acrylic rubber (ACM), fluoro rubber (CFM), chlorosulfonated polyethylene (CSM), ethylene-propylene copolymer (EPM), ethylene propylene diene rubber (EPDM), rubbers comprising nitrogen in the polymer chain, rubbers comprising oxygen in the polymer chain, rubbers comprising siloxane groups in the polymer chain, such as silicone rubbers MQ, PMQ, PVMQ or VMQ, rubbers comprising an unsaturated carbon backbone chain (R-rubbers), such as butadiene rubber (BR), chloroprene rubber (CR), butyl rubber (HR), isoprene rubber (NR), nitrile rubber (NBR), styrene butadiene rubber, or halobutyl rubbers. It has been found to be particularly advantageous to form the pressure compensation element from NBR rubber. This is particularly resistant to fats and oils, and furthermore exhibits good ageing properties. Nitrile rubber having an acrylonitrile content of 20 to 30 wt. % based on the total mass of the nitrile rubber has been found to be particularly advantageous. The lower acrylonitrile content has a positive effect on the resiliency.

In order to improve the UV stability of the pressure compensation element, the composition thereof further comprises, in addition to the at least one elastomer, at least a fraction of at least one thermoplastic. The thermoplastic is advantageously formed of polyvinyl chloride (PVC). The overall composition of the pressure compensation element advantageously comprises polyvinyl chloride in the range of from 15 to 35 wt. % based on the total mass, wherein a polymer blend is advantageously formed.

Using at least one elastomer as a component of the pressure compensation element is advantageous insofar as the resilient properties of the pressure compensation element can be provided in a simple manner as a result.

In a further advantageous embodiment, the pressure compensation element has a C-profile in cross-section. This is advantageous since this C-profile allows for particularly simple pressure compensation. In the simplest case, the cross section of the pressure compensation element has a wall thickness in the range of from 0.1 mm to 0.8 mm. A wall thickness of 0.2 mm, 0.25 mm, 0.3 mm, 0.35 mm, 0.4 mm, 0.45 mm, 0.5 mm, 0.55 mm, 0.6 mm or 0.65 mm has been found to be particularly advantageous. At this wall thickness, the sealing element exhibits the best possible, resilient properties.

The wall thickness may be designed so as to be constant and/or variable. Advantageously at least one, in particular a plurality of, wall region portions are provided which have a reduced wall thickness. This is advantageous in particular because, as a result, resilient deflection of the pressure compensation element is achieved even more easily, at an already low application of force. Reducing the wall thickness makes it possible for the pressure compensation element to react quickly to pressure changes of the fluid medium. This is advantageous because additional stabilization of the fluid medium is provided thereby, and therefore the air bubble formation is further significantly reduced.

In a further advantageous embodiment, the lateral surface of the housing comprises at least one passage opening in the form of a perforation, which allows for medium exchange between the housing volume spanned by the cover part, base part and lateral surface, and the additional pressure compensation element volume spanned by the pressure compensation element, wherein the pressure compensation element volume and the housing volume form the capsule volume, which is completely filled with fluid medium upon the first filling therewith.

Said at least one passage opening allows for the fluid medium to move or flow when there is a pressure increase in the housing. The fluid medium can flow through the at least one passage opening. The pressure compensation element yields to the expansion of the fluid medium and is deformed thereby.

Furthermore, providing said at least one perforation makes it possible for the entire compass capsule, i.e. the housing and the pressure compensation element surrounding the housing, to be completely filled with fluid medium. It is not necessary to provide free air regions within the capsule volume. In contrast, this is specifically not desirable and not expedient for the function and object of the invention described herein. Only the resilient pressure compensation element is provided and used for the necessary pressure compensation in the case of expansion or shrinking of the fluid medium volume. The invention described herein provides the best functionality if the first instance of filling with the fluid medium is performed completely, such that the entire capsule volume is provided with medium.

In a further advantageous embodiment, the lateral surface is designed so as to be straight and/or curved. The geometric design of the lateral surface is dependent on the way in which the compass capsule itself is designed. In the case of a cylindrical compass capsule according to the present invention, the lateral surface is advantageously designed so as to be straight, or linear. However, if the compass capsule described herein is provided as a spherical compass capsule, it has been found to also be advantageous to form the lateral surface so as to be convexly curved.

In a further advantageous embodiment, the lateral surface comprises two projections that are arranged in a peripheral manner. These two projections are intended for receiving and fixing the pressure compensation element. In the simplest case, the C-profile-shaped pressure compensation element is guided over the two projections and engages therebehind.

Furthermore, the two projections are advantageously designed so as to extend away from one another, obliquely to the outside. This ensures an additional clamp function. Owing to the C-profile thereof, the resilient pressure compensation element can be easily snapped, clicked or plugged onto the projections of the lateral surface that are designed so as to be complementary thereto. At the same time, the resilient property of the pressure compensation element is associated with a sealing effect, such that, at best, additional sealing rings can be omitted. It is also conceivable, however, for the purpose of securing, to adhesively bond the pressure compensation element to the two projections accordingly, in order to thus create a connection that is guaranteed to be leak-proof.

Furthermore, the two mutually facing projection surfaces are formed so as to be curved, at least in part. Particularly advantageously, both projection surfaces have an S-shaped curvature. This forms a volume increase of the pressure compensation element volume. This is advantageous for the pressure compensation efficiency of the pressure compensation element. Furthermore, the S-shaped design of the two projection surfaces is advantageous for discharging an undesired air bubble from the housing itself.

If a disruptive air bubble has unexpectedly formed in the housing, this can be transferred out of the housing volume through one of the passage openings, through the lateral surface, and into the pressure compensation element volume. This can be achieved for example by tilting the compass capsule or by means of rapid movement back and forth. In order to achieve improved, permanent retention of the air bubble in the pressure compensation element volume, the projections of the lateral surface comprise the S-shaped, mutually facing surfaces. As a result of the S-shape, in the unloaded state, i.e. when no force is acting on the pressure compensation element, a gap forms between the respective projection and the pressure compensation element. Owing to the density thereof, the air bubble settles in said gap autonomously. Owing to the gap formation, the air bubble is retained there, and thus permanently removed from the housing. Furthermore, an air bubble that is trapped in this manner does not affect the pressure compensation behavior of the pressure compensation element, and therefore said element continues to fulfil its function.

Furthermore, a plurality of perforations, i.e. passage openings, that are arranged so as to be diametrically offset relative to one another, are arranged in the lateral surface, which perforations are designed for medium exchange and pressure compensation between the housing volume and the pressure compensation element volume. If, owing to extremely large temperature fluctuations, an air bubble should form in the compass capsule described herein, said bubble can be transferred out of the housing and into the pressure compensation element volume, via the passage openings that are provided accordingly. In this respect, it is expedient for the perforations, i.e. the passage openings, in the lateral surface to be arranged so as to be offset relative to one another, on the periphery. An alignment line between opposing passage openings should be prevented. This ensures that, once trapped in the pressure compensation element, air bubbles also cannot be returned into the housing.

Furthermore, the capsule described herein is used in any desired configuration, for example in a cylindrical or spherical shape, as a component of a compass and/or as a component of an optical device, for example binoculars or a telescope.

It is furthermore also conceivable for the pressure compensation element to have resiliency properties that are developed to different extents. For example, the two limbs of the C-profile may have less resilient properties than the base that connects the two limbs. As a result, said base can be deformed more easily, which is desirable in particular in the case if the present invention.

In addition to the at least one plasticizer as an additive, the pressure compensation element can also comprise further additives, for example amine-based stabilizers (N-Phenyl-2-naphthylamine) for improving the ageing resistance, or fillers for improving strength.

Advantages and expedient characteristics can be found in the following description, in conjunction with the drawings.

### IN THE DRAWINGS

FIG. 1 is a cross section of a compass capsule according to the invention;

FIG. 2 is a schematic view of a pressure compensation element; and

FIG. 3 is a schematic view of a further pressure compensation element.

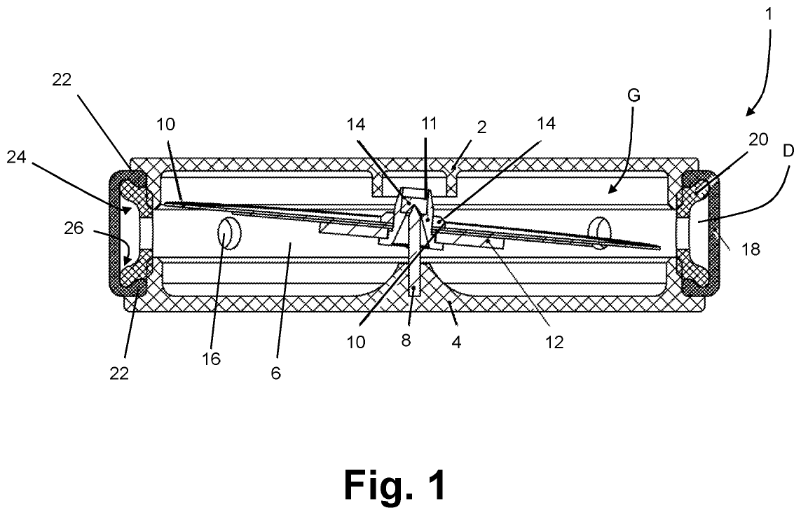

FIG. 1 is a schematic cross section of a compass capsule 1 according to the invention. Said capsule comprises a cover part 2 and a base part 4 which are rigidly interconnected via a common lateral surface 6. Furthermore, the base part 4 comprises a bearing device 8. Said bearing device is advantageously designed as a pin, on which the scale device 10 is arranged, by means of a bearing 11, so as to be rotatably mounted. The scale device 10 is designed as a rose and comprises at least one magnet 12 on the lower face thereof. For the purpose of fastening and/or balancing the scale device 10, at least one washer 14 may furthermore be provided. Said arrangement is expedient for the use of the compass capsule 1 for determining the cardinal direction.

The cover part 2, the base part 4 and the lateral surface 6 span the housing volume G. Together with the pressure compensation element 18, which is designed as a C-profile, the part of the lateral surface 6 that is arranged outside the housing, spans the pressure compensation element volume D. The housing volume G and pressure compensation element volume D together form the capsule volume K.

The lateral surface 6 is designed so as to be peripheral and surrounding. Said surface creates a parallel mutual spacing between the cover part 2 and the base part 4. The compass capsule 1 shown herein is cylindrical.

The lateral surface 6 comprises a plurality of perforations which are formed as passage openings 16. The passage openings 16 allow for a flow of medium between the housing volume G and the pressure compensation element volume D that is formed by the pressure compensation element 16 that spans the lateral surface.

Furthermore, the passage openings 16 are also to be understood as perforations, through which air bubbles which may have formed can be removed from the housing volume G and trapped in the pressure compensation element volume D. For this purpose, the pressure compensation element 18 has a C-profile, wherein the two limbs 22 of the pressure compensation element 18 engage behind the two projections 20 of the lateral surface 6 that are arranged peripherally around the cover part 2 and base part 4.

Particularly advantageously, the two projections 20 are designed so as to be complementary to the two limbs 22, such that a form- and/or force-fitting operative connection is formed by means of plugging, snapping or clicking the two limbs 22 onto the projections 20. Both the projections 20 and the two limbs 22 are designed and arranged, overall, so as to completely surround the cover part 2 and base part 4.

The mutually facing projection surfaces 24 are S-shaped. Said surfaces have an S-shaped course towards the outside. This provides for expansion and a surface increase towards the outside. In the case of a fixedly arranged pressure compensation element 18, a gap 26 is formed between said element and the S-shaped projection surfaces 24. Air bubbles that are undesired in the housing can be transferred into and quasi trapped in said gap 26. This is possible for the first time due to the particular S-shaped design of the projection surfaces 24. Permanently arranging undesired air bubbles in said gap 26 does not influence the pressure compensation behavior of the resilient pressure compensation element 18, and the full functionality of said element is ensured.

If the compass capsule 1 is exposed to an increased temperature for example, as a result of the coefficients of thermal expansion thereof the materials of the cover part 2, base part 4 and lateral surface 6 react differently from the coefficient of thermal expansion of the fluid medium. Paraffin oil and/or petroleum is advantageously used as the fluid medium. The fluid medium expands more significantly than the cover part 2, base part 4 or lateral surface 6. As a result, the force resulting from the expansion behavior is guided through the passage openings 16, counter to the pressure compensation element 18. Said element is designed so as to be resilient. The acting compressive force results in elastic deformation of the pressure compensation element 18 and thus to corresponding force dissipation. The resulting pressure inside the compass capsule 1 is compensated by the pressure compensation element 18. Said element yields. In the simplest and best embodiment, this does not result in any air bubbles in the compass capsule itself.

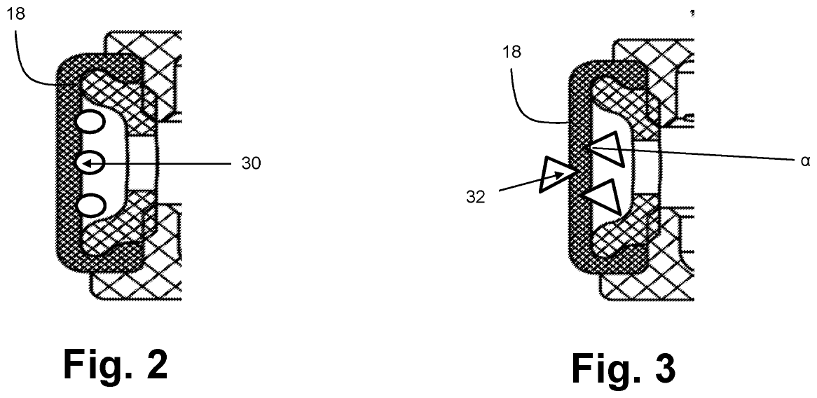

FIG. 2 is a schematic detail of a pressure compensation element 18. The same components as hitherto are provided with the same reference signs and have the same functionality, and are not explained again. The pressure compensation element 18 has a different wall thickness. In the example shown herein, the inner face 28 that faces the housing is formed having three material tapers 30. This additionally improves the resilient behavior of the pressure compensation element 18, in particular if the material tapers are formed having a depth of from 0.1 to 0.5 mm.

The same also applies for the embodiment of a further pressure compensation element 18, shown schematically in FIG. 3. Said element comprises wedge-shaped recesses 32 on either side. This design, too, improves the resilient behavior of the pressure compensation element 18, in particular if the wedge-shaped recesses 32 have a depth of from 0.1 mm to 0.5 mm, more advantageously 0.3 mm, and an angle in the range of from 20° to 80°, more advantageously 50°.

All the features disclosed in the application documents are claimed as being essential to the invention, insofar as they are novel, individually or in combination, over the prior art.

### LIST OF REFERENCE SIGNS

1 compass capsule
2 cover part
4 base part
6 lateral surface
8 bearing device
10 scale device
11 bearing
12 magnet
14 washer
16 passage opening
18 pressure compensation element
29 projections
22 limb
24 S-shaped projection surface
26 gap
28 inner face
30 material taper
32 wedge-shaped recess
K capsule volume
D pressure compensation element volume
G housing volume
α angle

1. A capsule (1) for a compass, comprising at least
a. a housing that is formed in multiple parts and is intended for receiving at least one scale device (10) for reading off at least one geographical specification, wherein the scale device (10) is arranged in a manner mounted on a bearing device (8), and the housing comprises a cover part (2) for closing the housing at the top, and a base part (4) for closing the housing at the bottom, wherein the cover part (2) and base part (4) are rigidly interconnected around the periphery by means of a perforated lateral surface (6), and
b. furthermore a pressure compensation element (18) that is arranged peripherally around the housing and spans the lateral surface (6) at least in part, which element is intended for compensating pressure fluctuations of a fluid medium arranged in the compass capsule (1), wherein the pressure compensation element (18) is designed so as to be resilient.

2. The capsule for a compass according to claim 1, characterized in that the pressure compensation element (18) is formed of at least one plastics material, at least one metal foil, or at least one composite material, or a combination thereof.

3. The capsule for a compass according to claim 2, characterized in that the pressure compensation element (18) comprises at least one elastomer as a component.

4. The capsule for a compass according to claim 1, characterized in that the pressure compensation element (18) has a C-profile in cross section.

5. The capsule for a compass according to claim 1, characterized in that the lateral surface of the housing comprises at least one passage opening (16) in the form of a perforation, which allows for medium exchange between the housing volume (G) spanned by the cover part (2), base part (4) and lateral surface (6), and the additional pressure compensation element volume (D) spanned by the pressure compensation element (18), wherein the pressure compensation element volume (D) and the housing volume (G) form the capsule volume (K), which is completely filled with fluid medium upon the first filling therewith.

6. The capsule according to claim 1, characterized in that the lateral surface (6) is designed so as to be straight and/or curved.

7. The capsule according to claim 1, characterized in that the lateral surface (6) comprises two projections (20) that are arranged in a peripheral manner.

8. The capsule for a compass according to claim 7, characterized in that the two projections (20) are designed so as to extend away from one another, obliquely to the outside.

9. The capsule for a compass according to claim 7, characterized in that on the mutually facing projection surfaces 24 thereof, the projections 20 have an S-shaped course towards the outside.

10. Use of the capsule (1) according to claim 1, as a component of a compass and/or as a component of an optical device.
